(19) United States
(12) Patent Application Publication
(10) Pub. No.: US 2020/0062513 A1
(43) Pub. Date: Feb. 27, 2020

(54) CONVEYOR BELT CLEANING APPARATUS

(71) Applicants: George Hutchison, Coldstream (CA); IBL Solutions Ltd, Stony Plain (CA)

(72) Inventors: George Hutchison, Coldstream, BC (CA); Shawn Foley, Stony Plain, AB (CA)

(73) Assignee: IBL Solutions Ltd, Stony Plain, AB (CA)

(21) Appl. No.: 16/610,458

(22) PCT Filed: Apr. 23, 2018
(86) PCT No.: PCT/CA2018/050478

§ 371 Date: Nov. 1, 2019

Related U.S. Application Data
(60) Provisional application No. 62/500,363, filed on May 2, 2017.

(51) Int. Cl. B65G 45/10; B65G 45/12; B65G 45/26

(52) U.S. Cl. CPC B65G 45/10; B65G 45/26; B65G 45/12

(57) ABSTRACT

An apparatus for cleaning a conveyor belt comprises a suction hopper and a carry-back removing device. The suction hopper comprises a tapering hollow body having a wider upper end and a narrower lower end. The upper end comprises a lip surrounding an upwardly facing carry-back inlet. A carry-back outlet in is the vicinity of the lower end and is communicable with a suction device. A front facing air inlet slot is in a front side of the hopper body at the upper end and is fluidly coupled to the carry-back inlet. The carry-back removing device is mounted in the suction hopper inlet and comprises at least one contact member extending upwardly out of the carry-back inlet.

### FIELD

This disclosure relates generally to an apparatus for cleaning a conveyor belt.

### BACKGROUND

Known conveyor belt cleaning devices serve to remove debris and other unwanted material that remain on a conveyor belt of a conveyor system after the conveyor belt has rounded a drum at a discharge end of the conveyor system (known as “carry-back debris” or simply “carry-back”). Cleaning the conveyor belt is important to prevent the carry-back from clogging the conveyor system. One drawback of known conveyor belt cleaning devices is that removed carry-back typically falls inside a discharge chute, or simply falls to the ground, onto a location directly underneath the conveyor belt where the cleaning device is located. As a result, accumulated debris must be removed from time to time to avoid excessive build up.

Another drawback of known conveyor belt cleaning devices is that the unwanted material tends to accumulate on the cleaning device itself, which tends to cause the cleaning device to lose cleaning effectiveness, for example by losing close contact with the belt surface. As a result, an operator must stop the conveyor system operation regularly to clean and adjust the cleaning device to maintain adequate cleaning performance.

Yet another drawback of known conveyor belt cleaning devices is that certain types of carry-back include significant amounts of fugitive dust which increases cleanup costs. Such dust can be simply a nuisance, or can be dangerous to human health and/or may interfere with the operation of or even damage nearby equipment. When the dust is combustible, the formation of such fugitive dust can present a fire and explosion hazard which adds another challenge to the conveyor belt operation. Some known conveyor systems include dust control measures such as hoods or shrouds and dust suction machines at transfer and dump locations; however, such known dust control measures are not effective to remove dust that clings to the conveyor belt, because of static-charge, stickiness, or other reasons.

It is desirable to provide an improvement to known conveyor belt cleaning devices and a solution to at least one of the drawbacks of such conveyor belt cleaners.

### SUMMARY

According to one aspect of the disclosure, there is provided an apparatus for cleaning a conveyor belt, comprising a suction hopper and a carry-back removing device. The suction hopper comprises a tapering receptacle having a wide upper end, a narrow lower end and a side wall extending between the upper and lower ends. The upper end comprises a lip for contacting a surface of a conveyor belt. The suction hopper also comprises a carry-back inlet in the receptacle's upper end which is surrounded by the lip; the carry-back inlet serves to receive carry-back material from the conveyor belt into the receptacle. The suction hopper also comprises a carry-back outlet in the receptacle's lower end or in the side wall below the carry-back inlet; the carry-back outlet can couple to a suction device such that the carry-back material in the receptacle is discharged through the carry-back outlet. The suction hopper also comprises at least one air inlet in the side wall, which provides replacement air into the receptacle for the suction device. The carry-back removing device is mounted in the carry-back inlet and comprises at least one upwardly extending contact member for contacting the conveyor belt such that the carry-back material is removed from the conveyor belt.

The suction hopper can further comprise a plurality of gasket strips attached to the lip and which collectively form a gasket surrounding the carry-back inlet. The gasket strips can be composed of low friction anti-wear materials having a dynamic coefficient of friction of 0.02-0.38 and a static coefficient of friction of 0.01-0.42. A suitable material is an Ultrahigh Molecular Weight (“UHMW”) Polyethylene which has a dynamic coefficient of friction of 0.10-0.20 and a static coefficient of friction of 0.15-0.20. Other materials with similar low friction properties known to one skilled in the art can also be used.

The side wall can be comprised of a front side, a rear side, and a pair of lateral sides with at least one air inlet comprising a front air inlet in the front side of the side wall and/or a rear air inlet in the rear side of the side wall. The front air inlet can comprise a gap at a top edge of the front side of the side wall and a front flange that is vertically movably mounted to the front side of the side wall, such that the front flange is movable to cover at least some of the gap. The front flange can comprise a front portion of the lip. The front flange can be positioned such that the front air inlet has a cross-sectional area that provides a desired volume rate of air removed from the receptacle for a selected conveyor belt operating speed. The rear air inlet can comprise a slot in the rear side of the side wall and a rear cover that is vertically movably mounted to the rear side of the side wall such that the rear cover is movable to cover at least some of the slot. The rear cover can be positioned such that the rear air inlet has a cross-sectional area that is sufficient to provide an air volume that draws airborne particles inside the suction hopper receptacle and downwards towards the carry-back outlet.

The suction hopper can further comprise an inspection door in the side wall that is openable to provide access to the carry-back removing device.

The carry-back removing device can comprise a laterally extending frame with lateral openings; the at least one contact member can comprise a plurality of flexible scraping fingers mounted to the frame. The carry-back removing device can comprise a set of front scraping blades that comprise some of the scraping fingers and are located in proximity to a front side of the receptacle, and a set of rear scraping blades that comprise the rest of the scraping fingers and are located in proximity to a rear side of the receptacle.

The apparatus can further comprise at least one height adjustment mechanism comprising a bolt extending upwardly through the receptacle and contacting the carry-back removing device. The bolt is in threaded engagement with a part of the side wall such that adjusting the vertical position of the bolt relative to the side wall adjusts the height of the carry-back removing device relative to the receptacle. In one example, the apparatus comprises two height adjustment mechanisms, wherein each height adjustment mechanism is located in proximity to a lateral side of the receptacle, and wherein the frame of the carry back removing device comprises a bracket at each lateral side that contacts the bolt of each height adjustment mechanism.

The apparatus can further comprise a mounting member extending from the receptacle and is attachable to a fixed part of a conveyor system, such that the carry-back inlet is located underneath a conveyor belt of the conveyor system and the contact member of the carry-back removing device is contacting a surface of a segment of the conveyor belt passing over the carry-back inlet.

According to another aspect of the disclosure, there is provided a system for cleaning a conveyor belt, comprising the aforementioned suction hopper, the aforementioned carry-back removing device, and a suction device pneumatically coupled to the carry-back outlet of the suction hopper and operable to generate a suction sufficient to remove the carry-back material inside the receptacle.

### DRAWINGS

FIGS. 1(a) to (d) are respective perspective, top, back, and front views of a conveyor belt cleaning apparatus according to one embodiment.

FIGS. 2(a) to (d) are respective top, back, front and left side views of a suction hopper component of the conveyor belt cleaning apparatus shown in FIG. 1.

FIG. 3 is a perspective view of a conveyor belt scraper component of the conveyor belt cleaning apparatus shown in FIG. 1.

FIG. 4(a) is a sectioned front view of the conveyor belt cleaning apparatus shown in FIG. 1. FIG. 4(b) is a detailed view of a height adjustment mechanism shown in window M of FIG. 4(a).

FIG. 5 is a schematic view of a conveyor belt cleaning system comprising the conveyor belt cleaning apparatus shown in FIG. 1 and a suction pump.

### DETAILED DESCRIPTION

### Overview

Directional terms such as “top”, “bottom”, “upper”, “lower”, “vertically”, and “laterally” are used in the following description for the purpose of providing relative reference only, and are not intended to suggest any limitations on how any article is to be positioned during use, or to be mounted in an assembly or relative to an environment.

Additionally, the term “couple” and variants of it such as “coupled”, “couples”, and “coupling” as used in this description is intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

Furthermore, the singular forms “a”, “an”, and “the” as used in this description are intended to include the plural forms as well, unless the context clearly indicates otherwise.

Embodiments of the invention disclosed herein relate generally to a conveyor belt cleaning apparatus for removing carry-back accumulated on a return path of a conveyor belt, and transporting the removed carry-back and surrounding airborne particles (collectively referred to “carry-back material”) from the vicinity of the conveyor belt. Such a conveyor belt can be part of conveyor systems used in many different industries, such as bulk food handling and mining. The conveyor belt can be a common open style, or an enclosed style such as those sold under the High Roller™ brand. The conveyor belt cleaning apparatus generally comprises a carry-back removing component which physically separates carry-back from the conveyor belt surface, and a suction hopper component surrounding the carry-back removing component and which removes the separated carry-back and airborne particles away from the conveyor belt. The suction hopper component comprises a tapering receptacle having a wide upper end with a lip that contacts the conveyor belt surface, a narrow lower end and a side wall between the upper and lower ends, a carry-back inlet in the upper end that faces upwards towards the underside of the conveyor belt, a carry-back outlet in the lower end (or in the lower side wall), and at least one air inlet in the side wall. The carry-back outlet can be coupled to a suction device and the at least one air inlet provides replacement air for the suction device to operate to pneumatically convey the carry-back material from the conveyor belt cleaning apparatus to a remote location for storage or discard. A gasket can be provided on the receptacle's lip that extends around the carry-back inlet. The conveyor belt cleaning apparatus is positioned so that at least a portion of the gasket is in light contact with the underside of the conveyor belt, such that substantially all airborne particles that passes over the carry-back inlet can be suctioned into the suction hopper component. A front portion of the gasket can be vertically spaced from the conveyor belt surface to allow airborne particles travelling with the conveyor belt to enter the receptacle.

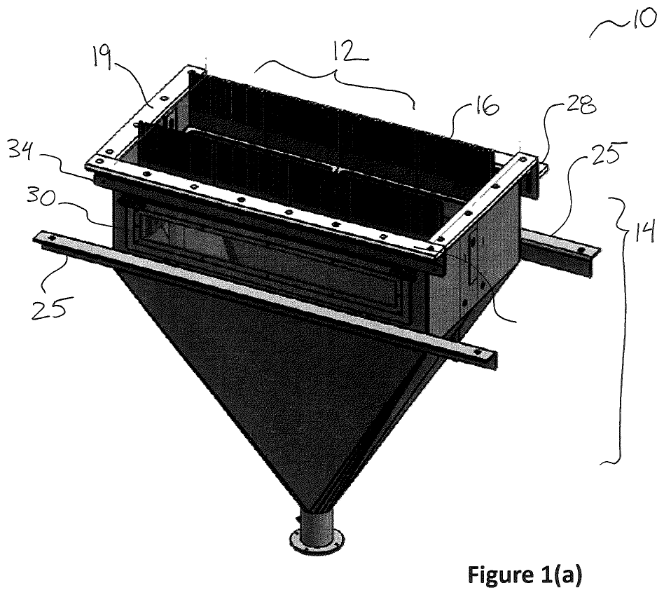

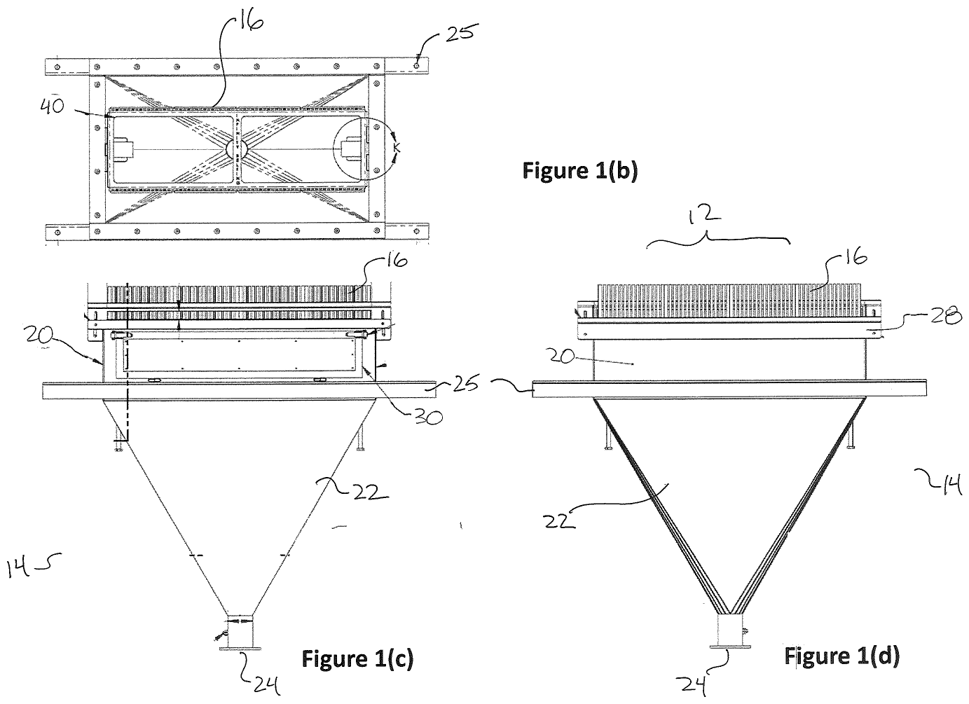

Referring to FIGS. 1(a) to (d) and according to one embodiment, a conveyor belt cleaning apparatus 10 generally comprises a carry-back removing component 12 and a suction hopper component 14. In this embodiment, the carry-back removing component 12 is a mechanical scraper device comprising scraping fingers 16 that are positioned relative to the underside of a conveyor belt (not shown) such that the scraping fingers 16 physically contact carry-back to dislodge the carry-back from the conveyor belt as it passes over the scraping fingers 16. The scraping fingers 16 conform to the smooth or cleated surface of the conveyor belt and flex upon contact with the conveyor belt surface. The mechanical scraper device 12 can have the same design as the conveyor belt cleaning apparatus disclosed in U.S. Pat. No. 9,376,264, which is herein incorporated by reference in its entirety. Alternatively, the carry-back removing component 12 can be a different design, and for example can be based on other known mechanical scraper devices that remove carry-back from the underside of a conveyor belt, such as a solid blade urethane scraper or a bristle brush scraper or a rubber style scraper cleaning apparatus.

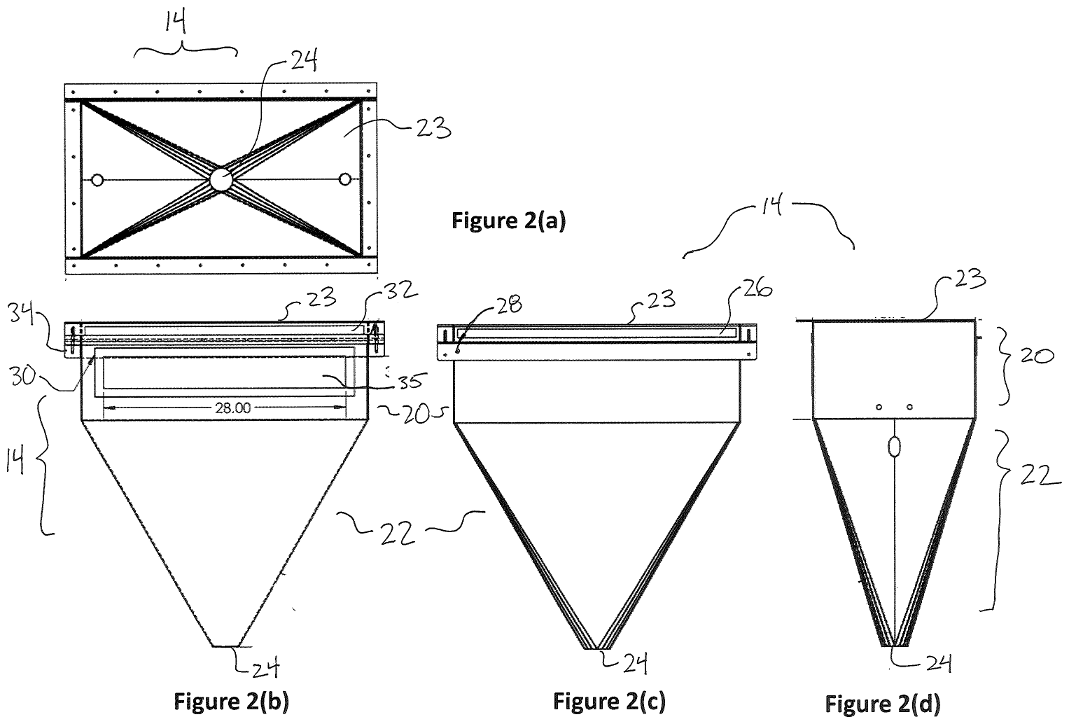

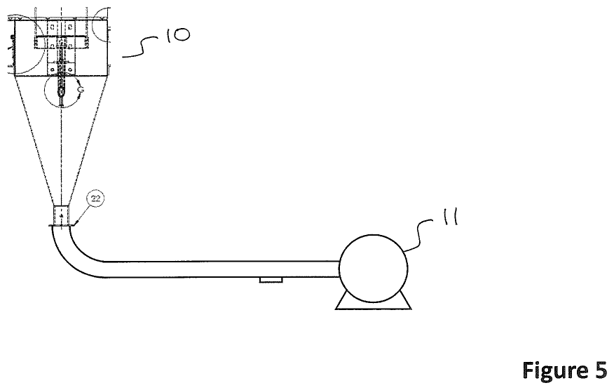

Referring to FIGS. 2(a) to (d), the suction hopper component 14 comprises a receptacle having a side wall comprising a generally rectangular upper section 20, and a tapering lower section 22. Both sections 20, 22 are made from a heavy gauge aluminum or alternatively with another comparable material that is groundable/bondable to discharge static electricity safely, in conformance with dust collection standards and regulations. The top of the rectangular upper section 20 serves as the intake end of the hopper and comprise a series of flanges, namely a front flange, a rear flange, and a pair of lateral flanges. The flanges collectively form a rectangular lip that defines the perimeter of a carry-back inlet 23 for receiving separated carry-back material. The carry-back inlet 23 has a width that generally corresponds to the width of the conveyor belt, and a depth that can accommodate all the scraping fingers 16 of the mechanical scraper device 12. Anti-wear strips (“gasket strips”) are attached to the lip and together form a gasket 19 that surrounds the carry-back inlet 23; these gasket strips can be comprised of low friction materials known in the art such as UHMW (Ultra High Molecular Weight) polyethylene, which has a dynamic coefficient of friction of 0.10-0.20 and a static coefficient of friction of 0.15-0.20. Other low friction materials having a dynamic coefficient of friction of 0.02-0.38 and a static coefficient of friction of 0.01-0.42 can also be used as an anti-wear material. Each gasket strip can be attached to a respective flange (hereinafter referred to as “front gasket strip”, “rear gasket strip”, and “lateral gasket strips”). The bottom of the lower section 22 serves as the lower end of the receptacle, and has a generally circular carry-back outlet 24 for coupling to a hose of a suction device 11 (shown schematically in FIG. 5). Although the outlet 24 in this embodiment is at the bottom of the receptacle, the outlet 24 can alternatively be located elsewhere on the receptacle side wall, provided it is below the inlet 23 and in the vicinity of the receptacle lower end. The suction device 11 is pneumatically coupled to the carry-back outlet 24 and can be operated to pneumatically convey carry-back removed by the scraping fingers 16 and airborne particles away from the apparatus 10. The suction device 11 in one embodiment can be part of a plant's existing dust control system, and in another embodiment can be a stand-alone suction device such as a vacuum pump or fan. Together, the conveyor belt cleaning apparatus 10 and the suction device 11 form a conveyor belt cleaning system.

The conveyor belt cleaning apparatus 10 further includes a pair of mounting rails 25 attached to the front and back sides of the suction hopper component 14, and which facilitate mounting the apparatus 10 to a fixed section of the conveyor system. The conveyor belt cleaning apparatus 10 can be mounted as close as possible to the head pulley of the conveyor system to minimize the amount of airborne particles that may disperse and carry-back that may fall off the conveyor belt before reaching the conveyor belt cleaning apparatus 10.

The suction hopper component 14 is mounted relative to the conveyor belt such that its front end (shown in FIG. 2(c)) faces the downstream end of the conveyor belt, i.e. the underside of the conveyor belt moves towards the front end of the suction hopper component 14. The conveyor system can be configured so that one or more return idler rollers are located on the inside of the conveyor belt line above the hopper component 14 of the apparatus 10. This configuration ensures that the segment of the belt that travels over the carry-back inlet 23 remains flat across the belt and across the direction of travel, and that light or bare contact is evenly maintained between the conveyor belt surface and at least the rear and lateral strips of the gasket 19. A feeler gauge (not shown) can be used during installation of the apparatus 10 to ensure there is light contact between the belt and the gasket 19. The contact should not be so much to cause component wear without improving carry-back removal and particle capture, and not be so little that will allow significant particle leakage.

During typical conveyor belt operation, a boundary layer of air is moving at the same velocity as the conveyor belt; essentially, air is pulled along by the moving conveyor belt. Simultaneously, air near the beltline of the conveyor belt is mostly still, and this creates turbulence between the moving air and the mostly stationary air, which tends to generate air borne particles (otherwise known as fugitive dust) from the carry-back. To account for the tendency of fugitive dust and other particulates moving in unison with the conveyor belt to deflect and disperse upon contact with the front end of the conveyor belt cleaning apparatus 10, an adjustable front air inlet 26 is provided at the top edge of the front side of the upper hopper section 20. This front air inlet 26 effectively provides a vertical gap between the front of the receptacle and the conveyor belt surface that is large enough to allow the airborne particles moving with the conveyor belt to enter the suction hopper component 14.

The front air inlet 26 also serves to provide replacement air for the suction device to pneumatically convey the carry-back material out of the suction hopper component 14. The cross-sectional area A of the front air inlet 26 can be adjusted to provide a desired volume rate of replacement air Q for a particular conveyor belt speed V (the replacement air volume rate Q is a function of the conveyor belt speed V and the air inlet cross sectional area A). The front air inlet 26 is height adjustable by way of a movable front flange 28 that is vertically movable over a gap in the top front side of the upper hopper section 20. The front gasket strip is mounted to the front flange 28, and when the front flange 28 is moved to its uppermost position, the front air inlet 26 is closed and the front gasket strip is flush with the lateral gasket strips. When the front flange 28 is moved to its lowermost position, the gap is fully exposed and the air inlet slot 26 is fully opened. The height of the front air inlet 26 can be selected depending on the operating speed of the conveyor belt, to provide a desired volume rate of air passing through the hopper component 14.

As can be seen in FIG. 2(b), the back side of the upper hopper section 22 includes an inspection door 30 and a rear air inlet 32 just below the rear lip of the hopper's upper intake end. The rear air inlet 32 comprises a slot in the rear side wall of the receptacle, and a rear cover 34. The rear cover 34 is vertically movable relative to the rear side wall of the receptacle and can be fixed in any vertical position between a top position wherein the rear cover 34 completely covers the slot, and a bottom position wherein the slot is fully exposed. The cross sectional area of the rear air outlet 32 can thus be adjusted to control the volume rate of the replacement air that passes through the hopper component 14, which is also expected to contribute to pulling airborne particles down and away from the mechanical scraper device 12 and down to the carry-back outlet. The inspection door 30 includes a window 35 and can be opened to allow an operator to check the mechanical scraper device 12, and in particular, check for wear in the scraping fingers 16.

While this embodiment features two air inlets 26, 32 at the front and rear sides of the hopper component 14 respectively, a different number of air inlets can be provided at different locations on the hopper component, according to alternative embodiments. For example, a single air inlet can be provided on a lateral side of the hopper component (not shown).

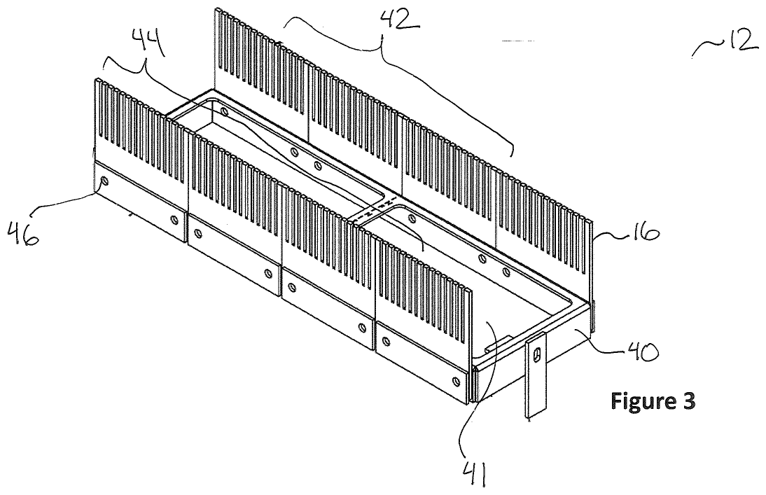

Referring now to FIG. 3, the mechanical scraper device 12 comprises a frame 40 having a forward side, rearward side, and lateral sides which together define a pair of frame openings 41. A plurality of front scraping blades 42 each include a plurality of scraping fingers 16, and are each positioned side-by-side and secured to the forward side of the frame 40 using mounting plates and mounting plate bolts (not shown). A plurality of rear scraping blades 44 each include a plurality of scraping fingers 16 is and are secured side-by-side to the rearward side of the frame 40 using mounting plates and mounting plate bolts 46. In operation, the frame openings 41 allow carry-back removed from the conveyor belt by the front scraping blades 42 to fall through the frame 40 and into the suction hopper component 14.

Although the illustrated embodiment shows the frame 40 with two openings 41, the frame 40 may alternatively include a different number of frame openings which allow debris removed from the conveyor belt by first scraping blades 42 to fall through frame 40 and thereby not accumulate on the frame 40. The size and orientation of the frame openings are selected to maximize debris clearance from frame 40 without having a significant adverse effect on the strength of frame 40.

The scraping blades 42 and 44 may be made from any suitable flexible material having a durometer rating between 60 and 100. Ideally, such materials also are easily pourable into a mold at elevated temperatures and solidify upon cooling to room temperature. Such materials include, for example, polyurethane, rubber and mixtures thereof. In one embodiment, each of the scraping blades 42 and 44 is made of polyurethane. In another embodiment, each of the scraping blades 42, 244 is made of a urethane and are rendered anti-static by means known in the art to avoid static ignition of combustible dust particles. In one embodiment, each of the scraping blades 42 and 44 has a durometer rating of from 65 to 95. In one such embodiment each of the scraping blades 42 and 44 has a durometer rating of from 85 to 95. In one such embodiment, each of the scraping blades 42 and 44 has a durometer rating of about 90.

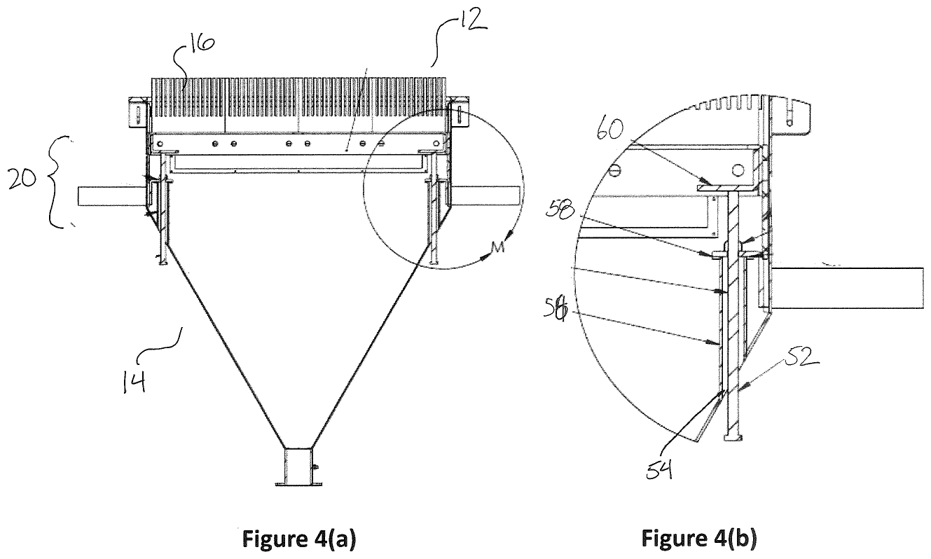

Referring now to FIGS. 4(a) and (b), the mechanical scraper device 12 is mounted inside the upper hopper section 20 such that the scraping fingers 16 protrude upwards and out of the inlet 23 of the upper hopper section 20. The mechanical scraper device 12 is vertically movably mounted to the suction hopper component 14 by a pair of height adjustment mechanisms, of which one is shown in detail in FIG. 4(b). Each height adjustment mechanism comprises a bolt 52 which extends through an opening 54 in the lower hopper section 24; a pipe 56 is welded to the inside surface of the lower hopper section 24 to seal the inside of the suction hopper component 12 from the outside environment. Each bolt 52 is threaded and engages a thread hole in a plate 58 at the top the pipe 56. The top end of the bolt 52 contacts a bracket 60 connected to each lateral side of the frame 40. Adjusting the vertical position of the bolt 52 thus adjusts the vertical position of the mechanical scraper device 12 relative to the suction hopper component 14. This allows the operator to adjust the position of the scraping fingers 16 relative to the conveyor belt as the fingers 16 wear.

In operation, carry-back material comprising accumulated carry-back and airborne particles are removed from the conveyor belt by the apparatus 10 in four stages. First, the suction device 11 is operated to generate a moving air stream that flows into the hopper component 14 via the front and rear air inlets 26, 32 with an air capture velocity that is preferably greater than the conveyor belt speed. As a segment of the conveyor belt reaches the front air inlet 26, airborne particles travelling with the conveyor belt segment passes through the vertical spacing between the front gasket portion and the conveyor belt surface, and into the hopper component 14. Second, the conveyor belt segment passes through the inlet slot 26 and the front scraping blades 42 contact the conveyor belt segment and scrapes carry-back off the conveyor belt surface. The third stage involves the conveyor belt segment contacting the rear scraping blades 44 to ensure the entire width of the conveyor belt is cleaned by mechanical contact with the scraping fingers 16. The scraping fingers of the rear scraping blades 44 rely on the movement of air created via the admission of replacement air through the rear air inlet slot 32 to draw carry-back particulate downward to the carry-back outlet 24 of the suction hopper component 14. Finally, the conveyor belt segment passes by the rear flange 34, wherein the rear and lateral gaskets act as a barrier to contain any airborne particles inside the hopper component 14 from escaping. The rear flange 34 is positioned so that the rear gasket is lightly touching the conveyor belt surface so that any carry-back material and particles not already removed during the first three stages is removed and suctioned into the hopper component 14.

The suction generated by the suction device 11 is sufficiently strong to ensure that fugitive dust inside the hopper body is pulled though the outlet 24 and away from the apparatus 10.

It can be seen from the operation of the conveyor belt cleaning apparatus 10, that carry-back material is removed from the conveyor belt surface and transported away in a single step. This provides an advantage over prior art cleaning devices which simply deposit removed material in the vicinity of the cleaning device and have no means of controlling fugitive dust generated by the conveyor system.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. An apparatus for cleaning a conveyor belt, comprising:
(a) a suction hopper comprising
a tapering receptacle having a wide upper end, a narrow lower end and a side wall extending between the upper and lower ends, the upper end comprising a lip for contacting a surface of a conveyor belt;
a carry-back inlet in the upper end and surrounded by the lip, the carry-back inlet for receiving carry-back material from the conveyor belt into the receptacle;
a carry-back outlet in the lower end or in the side wall below the carry-back inlet, the carry-back outlet for coupling to a suction device such that the carry-back material in the receptacle is discharged through the carry-back outlet; and
a front air inlet in a front side of the side wall, the front air inlet for providing replacement air into the receptacle for the section device and comprising a gap at a top edge of the front side of the side wall; and
(b) a carry-back removing device mounted in the carry-back inlet and comprising at least one upwardly extending contact member for contacting the conveyor belt such that the carry-back material is removed from the conveyor belt.

2. The apparatus as claimed in claim 1 wherein the suction hopper further comprises a plurality of gasket strips attached to the lip and collectively forming a gasket surrounding the carry-back inlet.

3. The apparatus as claimed in claim 1 wherein the gasket strips are composed of an anti-wear material having a dynamic coefficient of friction of 0.02-0.38 and a static coefficient of friction of 0.01-0.42.

4. The apparatus as claimed in claim 3 wherein the gasket strips are composed of a material comprising Ultra High Molecular Weight (U.H.M.W.) polyethylene.

5. The apparatus as claimed in claim 1 wherein the side wall comprises a front side, a rear side, and a pair of lateral sides.

6. The apparatus as claimed in claim 5 wherein the front air inlet comprises a front flange vertically movably mounted to the front side of the side wall such that the front flange is movable to cover at least some of the gap, and wherein the front flange comprises a front portion of the lip.

7. The apparatus as claimed in claim 5 wherein the front flange is positioned such that the front air inlet has a cross-sectional area that provides a desired volume rate of air removed from the receptacle for a selected conveyor belt operating speed.

8. The apparatus as claimed in claim 5, wherein the at least one air inlet further comprises a rear air inlet in the rear side of the side wall.

9. The apparatus as claimed in claim 8 wherein the rear air inlet comprises a slot in the rear side of the side wall, and a rear cover vertically movably mounted to the rear side of the side wall such that the rear cover is movable to cover at least some of the slot.

10. The apparatus as claimed in claim 9 wherein the rear cover is positioned such that the rear air inlet has a cross-sectional area that provides a desired volume rate of air to draw airborne particles inside the suction hopper receptacle downwards towards the carry-back outlet

11. The apparatus as claimed in claim 1 wherein the suction hopper further comprises an inspection door in the side wall that is openable to provide access to the carry-back removing device.

12. The apparatus as claimed in claim 1 wherein the carry-back removing device comprises a laterally extending frame with lateral openings and the at least one contact member comprises a plurality of flexible scraping fingers mounted to the frame.

13. The apparatus as claimed in claim 12 wherein the carry-back removing device comprises a set of front scraping blades comprising some of the scraping fingers and located in proximity to a front side of the receptacle, and a set of rear scraping blades comprising the rest of the scraping fingers and located in proximity to a rear side of the receptacle.

14. The apparatus as claimed in claim 1 further comprising at least one height adjustment mechanism comprising a bolt extending upwardly through the receptacle and contacting the carry-back removing device, the bolt in threaded engagement with a part of the side wall such that adjusting the vertical position of the bolt relative to the side wall adjusts the height of the carry-back removing device relative to the receptacle.

15. The apparatus as claimed in claim 14 further comprising two height adjustment mechanisms, each height adjustment mechanism located in proximity to a lateral side of the receptacle, and wherein the frame of the carry back removing device comprises a bracket at each lateral side that contacts the bolt of each height adjustment mechanism.

16. The apparatus as claimed in claim 1 further comprising a mounting member extending from the receptacle and attachable to a fixed part of a conveyor system, such that the carry-back inlet is located underneath a conveyor belt of the conveyor system and the contact member of the carry-back removing device is contacting a surface of a segment of the conveyor belt passing over the carry-back inlet.

17. A system for cleaning a conveyor belt, comprising:
(a) a suction hopper comprising
a tapering receptacle having a wide upper end, a narrow lower end and a side wall extending between the upper and lower ends, the upper end comprising a lip for contacting a surface of a conveyor belt;
a carry-back inlet in the upper end and surrounded by the lip, the carry-back inlet for receiving carry-back material from the conveyor belt into the receptacle;
a carry-back outlet in the lower end or in the side wall below the carry-back inlet, the carry-back outlet for coupling to a suction device such that the carry-back material in the receptacle is discharged through the carry-back outlet; and
a front air inlet in a front side of the side wall, the front air inlet for providing replacement air into the receptacle for the section device and comprising a gap at a top edge of the front side of the side wall;
(b) a carry-back removing device mounted in the carry-back inlet and comprising at least one upwardly extending contact member for contacting the conveyor belt such that the carry-back material is removed from the conveyor belt; and
(c) a suction device pneumatically coupled to the carry-back outlet and operable to generate a suction sufficient to remove the carry-back material inside the receptacle.
